(19) United States
(12) Patent Application Publication
(10) Pub. No.: US 2004/0000464 A1
(43) Pub. Date: Jan. 1, 2004

(54) Article row former

(75) Inventor: Brian E. Busse, Randolph, WI (US)

Correspondence Address: MICHAEL BEST & FRIEDRICH, LLP, 100 E WISCONSIN AVENUE, MILWAUKEE, WI, 53202, US

(73) Assignee: Busse/SJI, Corp., Randolph, WI

(21) Appl. No.: 10/610,109

(22) Filed: Jun. 30, 2003

Related U.S. Application Data
(60) Provisional application No. 60/392,811, filed on Jul. 1, 2002.

(51) Int. Cl. B65G 47/26; B65G 47/68

(52) U.S. Cl. 198/442; 198/437; 198/617

(57) ABSTRACT

An article row former for arranging an unorganized stream of articles into a plurality of rows. The row former includes a conveyor for conveying articles in a flow direction and a frame. A support assembly is slideably coupled to the frame for movement above the conveyor substantially parallel to the flow direction, and a carriage assembly is slideably coupled to the frame for movement above the conveyor substantially perpendicular to the flow direction. Each of a plurality of elongated guides has an upstream end that is pivotally coupled to the support assembly, and a downstream end that is pivotally coupled to the carriage assembly. The guides define a plurality of guide channels that receive the articles. Each of a plurality of starwheels is rotatably coupled to the downstream end of a respective guide, and rotate in timed relation with the movement of the carriage assembly to control the release of articles from the guide channels.

### RELATED APPLICATION

This application claims the benefit of Provisional Application No. 60/392,811 filed on Jul. 1, 2002, which is incorporated herein by reference.

### BACKGROUND OF THE INVENTION

1. Technical Field

The invention relates to row formers, and more particularly to staggered row formers for handling bottles, cans, and other generally cylindrical containers.

2. Background Information

Row forming machines for forming staggered rows of cylindrical objects such as beverage containers, food containers, and the like are known. Known row forming machines are positioned along a conveyor or similar mechanism conveying an unorganized stream of steel cans or similar, often cylindrical containers. The row forming machines guide the random stream of containers into a plurality of substantially parallel guide channels. Each guide channel terminates at a rotating star wheel that includes recesses that each receive an individual container. As the star wheels rotate, the containers are guided and arranged into uniformly spaced rows. The uniform rows of containers are then guided further along the conveyor to additional downstream processing equipment.

### SUMMARY OF THE INVENTION

The present invention provides a row former for arranging an unorganized stream of articles into a plurality of rows. The row former includes a conveyor that conveys the articles in a flow direction and a frame adjacent the conveyor. A plurality of elongated guides are coupled to and supported by the frame for oscillatory movement above the conveyor. The guides oscillate between a first position and a second position. A plurality of guide channels are defined by and extend between the guides to receive and guide the articles. A plurality of shafts are supported by the frame and move in timed relation with respect to the oscillating guides to intermittently allow articles to flow out of the guide channels.

The present invention may also provide an article row former for arranging an unorganized stream of generally cylindrical articles into a plurality of rows. The article row former includes a conveyor for conveying the articles in a flow direction and a frame adjacent the conveyor. A carriage is coupled to the frame for translational movement in a direction that is substantially perpendicular to the flow direction. The article row former also includes a motor that is supported by the carriage for movement therewith and that drivingly rotates a cam. A cam follower is coupled to the frame and engages the cam such that the carriage oscillates in response to rotation of the cam. The article row former further includes a plurality of guides, and each guide has a first end that is supported by the carriage for oscillation therewith, and a second end that is supported by the frame.

The present invention may further provide an article row former including a conveyor for conveying articles in a flow direction, a frame adjacent the conveyor, and a plurality of article guides supported by the frame. The article guides define a plurality of substantially parallel guide channels that extend in the flow direction. Each guide includes an upstream end that guides individual articles into one of the guide channels, and a downstream end having a curved portion that diverts the articles prior to releasing the articles from the guide channels. The curved portions are configured to divert the articles in a direction that is angled with respect to the flow direction.

In addition, the present invention may provide an article row former including a frame, and a plurality of guides supported by the frame and defining guide channels, each guide having an upstream end and a downstream end. A plurality of starwheels are each rotatably coupled to a downstream end of a respective guide and control the release of articles from the guide channels. The article row former also includes a plurality of drive pulleys. Each drive pulley is coupled to a respective starwheel for imparting rotation thereto. A motor is coupled to the frame, and a flexible drive member is driven by the motor and engages each drive pulley. The article row former further includes a sensor pulley that is coupled to the frame and that engages the flexible drive member. A sensor is operatively associated with the sensor pulley and senses movement of the sensor pulley in response to an increase in tension of the flexible drive member.

Also, the present invention may provide an article row former including a conveyor for conveying articles in a flow direction and a frame having a first frame rail on one side of the conveyor, and a second frame rail on an opposite side of the conveyor. A support assembly is slideably coupled to at least one of the frame rails for movement substantially parallel to the flow direction, and a carriage assembly is slideably coupled to the frame rails for movement substantially perpendicular to the flow direction. Each of a plurality of guides has an upstream end that is pivotally coupled to the support assembly, and a downstream end that is pivotally coupled to the carriage assembly.

Furthermore, the present invention may provide a method for clearing jams in an article row former that includes a conveyor for conveying articles in a flow direction, a frame adjacent the conveyor, and a plurality of article guides supported by the frame and defining a plurality of substantially parallel guide channels that extend in the flow direction. The method includes sensing the absence of an article in one of the guide channels, and waiting for a period of time corresponding to a feed rate at which articles flow from the guide channels. If there is a continued absence of an article in the one guide channel after waiting for the period of time, jam remediation operations are automatically performed. The article row former is operated normally after performing the jam remediation functions, and the absence or presence of an article in the one guide channel is again checked. If there is still an absence of an article in the one guide channel, an operator is alerted.

### BRIEF DESCRIPTION OF THE DRAWINGS

FIG. 1 is a top view of a row forming system embodying the invention.

FIG. 2 is an enlarged view of a guide portion of the row-forming machine of FIG. 1.

FIG. 3 is a further enlarged view of the guide portion of FIG. 2 in a first position.

FIG. 4 is an enlarged view similar to FIG. 3 showing the guide portion in an intermediate position.

FIG. 5 is an enlarged view similar to FIG. 3 showing the guide portion in a second position.

FIG. 6 is an enlarged top view of an accumulator section of the row forming system of FIG. 1.

FIG. 7 is a section view taken along line 7-7 of FIG. 11.

FIG. 8 is a rear view of the accumulator section of FIG. 6.

FIG. 9 is a section view taken along line 9-9 of FIG. 6.

FIG. 10 is an end view of the accumulator section of FIG. 6.

FIG. 11 is section view taken along line 11-11 of FIG. 1.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION OF THE PREFERRED EMBODIMENT

The drawings illustrate a row forming system 10 embodying the present invention. The system 10 is positioned above a conveyor belt 14 and receives an incoming stream 18 of unorganized cylindrical objects such as glass bottles 22. The system 10 receives the incoming stream 18 of bottles 22 and organizes them into an outgoing stream 26 of staggered rows 30a, 30b of bottles 22. The system 10 is particularly well suited for use in a bottling or canning operation for example, and may be positioned directly upstream of a palletizer or similar device that requires products to be delivered thereto in staggered rows. It should be understood that glass bottles 22 are only one example of cylindrical objects that might be delivered to the system 10. The system is equally well suited to handle other objects such as steel or aluminum cans, and plastic containers, among other things.

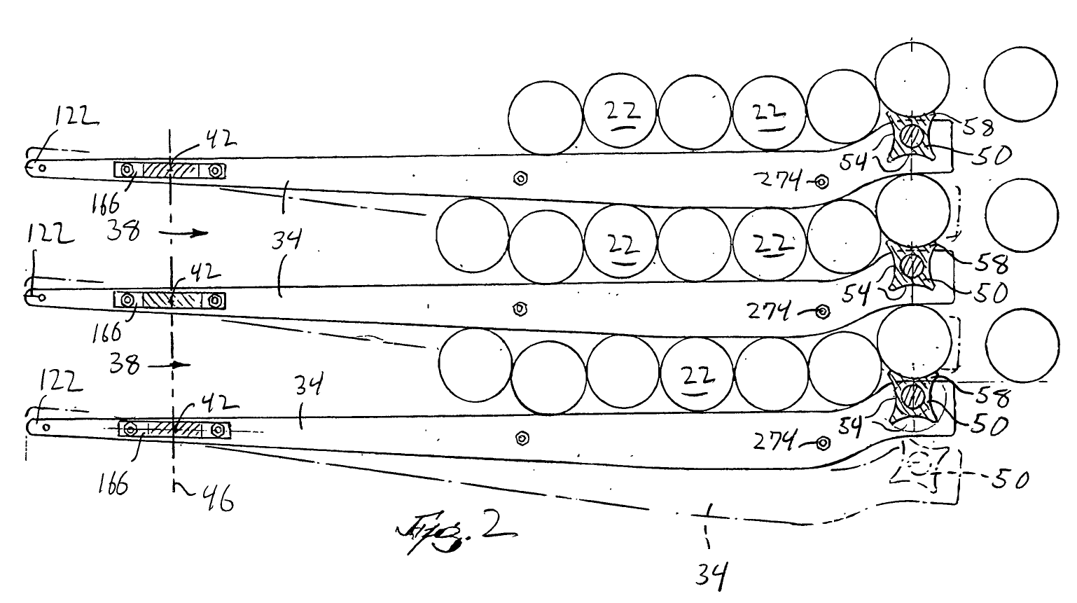

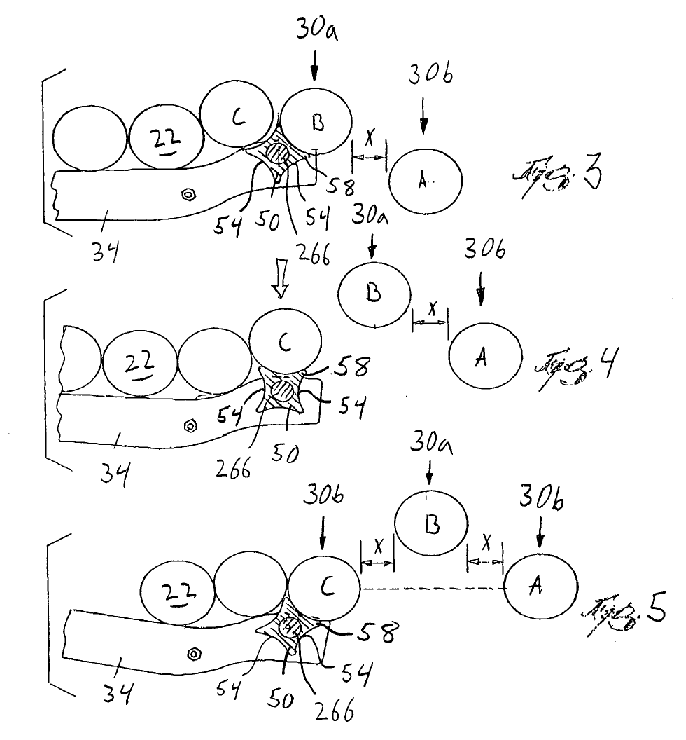

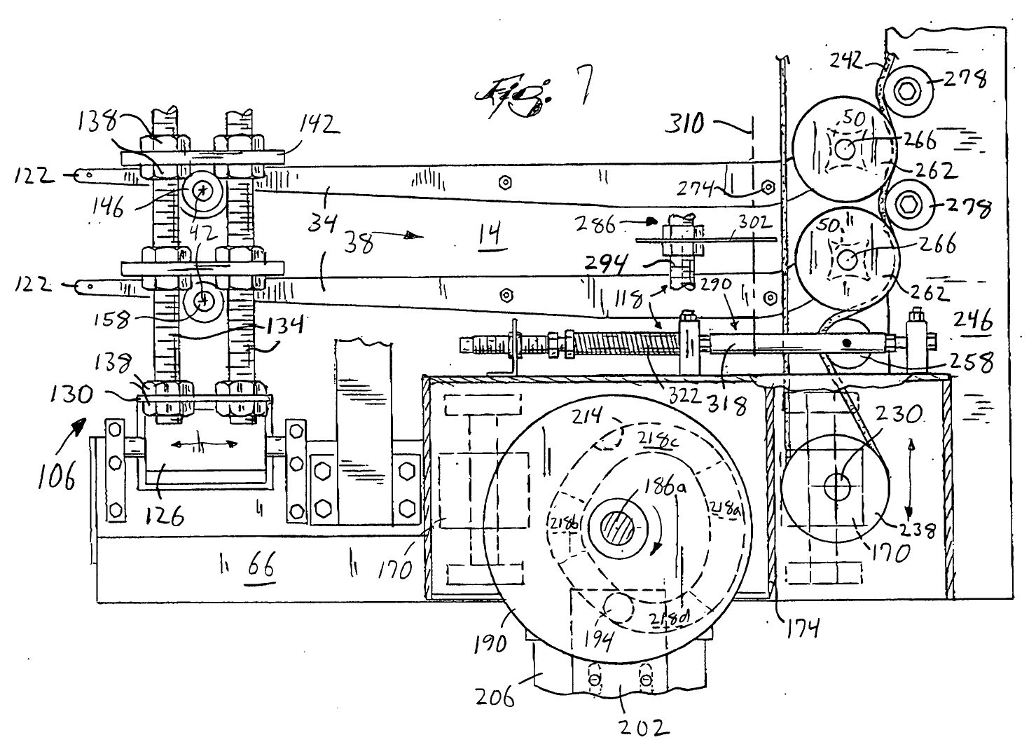

FIGS. 2-5 illustrate how the system 10 organizes the bottles 22 into the substantially uniform, staggered rows 30a, 30b. As shown in FIG. 2, elongated guides 34 cooperate to define substantially parallel bottle-receiving channels 38. The guides 34 are supported above the conveyor belt 14 in a manner described further below. Each guide 34 is pivotal about a respective pivot axis 42 and is drivingly oscillated thereabout between a first position (see FIG. 3 and solid lines of FIG. 2), and a second position (see FIG. 5 and phantom lines of FIG. 2). The pivot axes 42 are all substantially parallel to each other and lie in a common plane 46 that is substantially perpendicular to the direction of travel of the conveyor belt 14.

A starwheel assembly 50 is rotatably coupled to the downstream end of each guide 34. Each starwheel assembly 50 defines a plurality (e.g. four as illustrated) of bottle-receiving recesses 54. The starwheel assemblies 50 are drivingly rotated in timed synchronization with the driven oscillatory movement of the guides 34. Specifically, for a starwheel assembly 50 having four recesses 54, each time the guides 34 pivot from the first position to the second position, or from the second position to the first position, the starwheel assembly 50 rotates approximately one-quarter of a turn. In this way, one bottle 22 is simultaneously delivered from each channel 38 each time the guides 34 pivot to one of the first and second positions, thereby forming the staggered rows 30a, 30b.

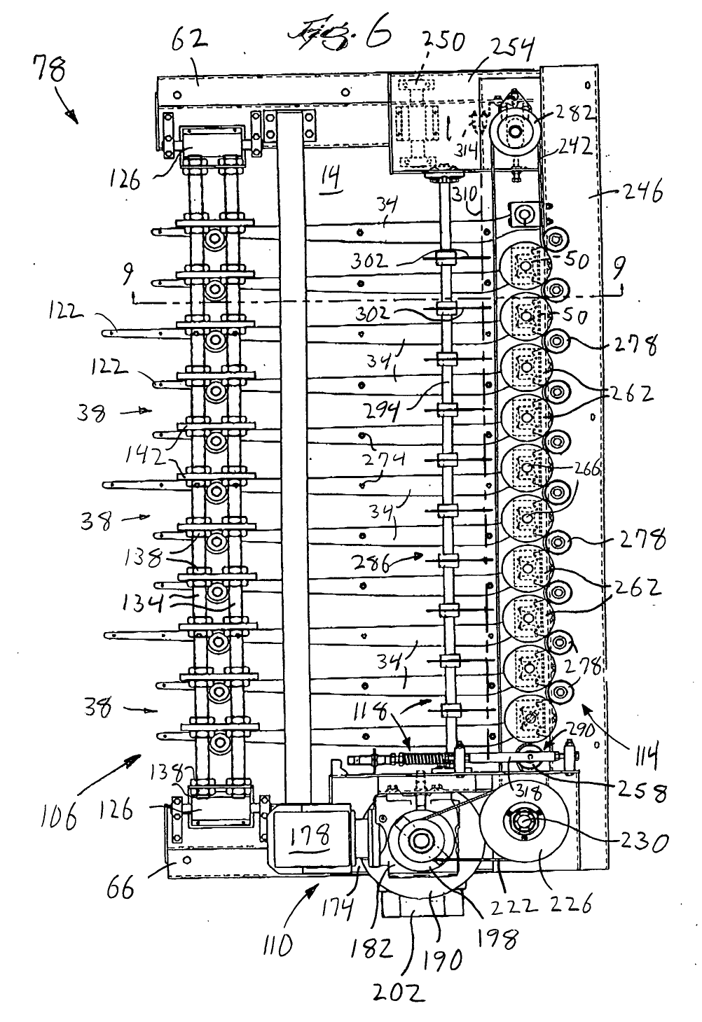

As illustrated in FIGS. 3-5, rotation of the starwheel assemblies 50 is timed such that when the guides 34 reach the first or second position, downstream ends 58 of the bottle-receiving recesses 54 are oriented to point substantially in the direction of travel of the conveyor belt 14 (see FIGS. 3 and 5). In this way, bottles 22 are held within the bottle receiving channel 38 by the starwheel assembly 50 during the guides' oscillations between the first and second positions (see FIG. 4), and are released onto the conveyor belt 14 when the guide 34 reaches the first or the second position.

The starwheel assemblies 50 are rotated at an angular velocity having a tangential component that is less than the linear velocity of the conveyor belt 14. As such, the bottles 22 accumulate in the bottle receiving channels 38 and slideingly engage the conveyor belt 14 until such time as they are released from the bottle-receiving recesses 54 of the starwheel assemblies 50. The linear velocity of the conveyor belt 14 and the angular velocity of the starwheel assemblies 50 are selected to create a pre-determined spacing distance X between the staggered rows 30a, 30b of bottles 22. In general, increasing the differential between the conveyor belt velocity and the starwheel assembly velocity will increase the spacing distance X.

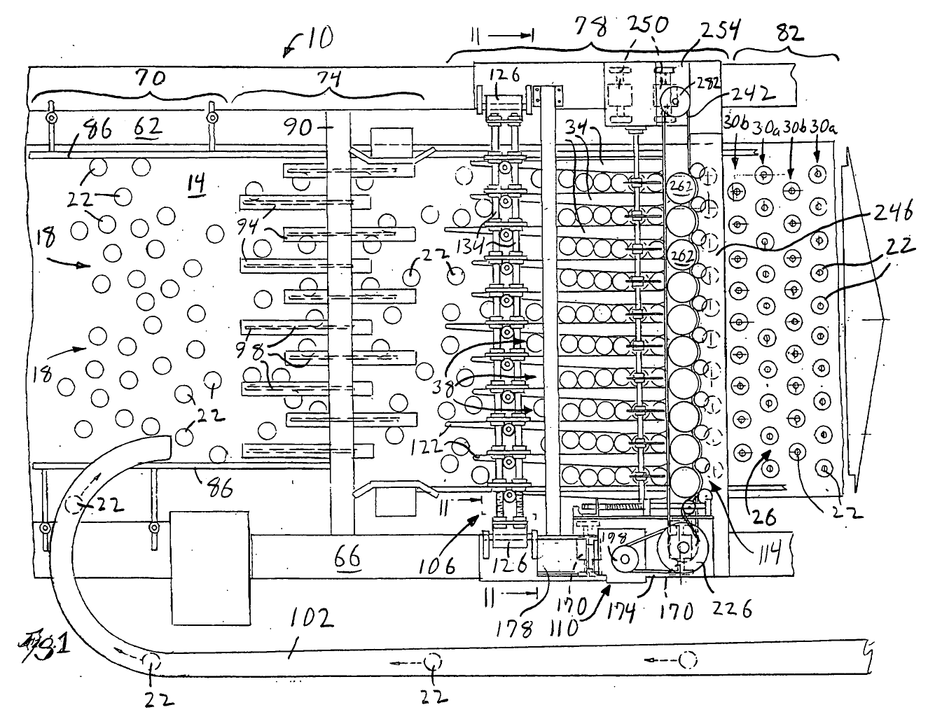

Referring back to FIG. 1, the system 10 includes a left main frame rail 62 and a right main frame rail 66. In a preferred embodiment of the invention, the frame rails 62, 66 are extruded channel sections. However, substantially any structural material or materials may be used in accordance with the teachings of the present invention, provided they have suitable strength and stiffness to support the various system components and their associated operating loads. The main frame rails 62, 66 support substantially all the components of four sections of the row forming system 10. Moving from the most upstream section (left-most in FIG. 1) toward the most downstream section (right-most in FIG. 1), the system 10 includes a receiving section 70, a breaker-bar section 74, an accumulating section 78, and a discharge section 82.

The receiving section 70 receives the incoming stream 18 of unorganized bottles 22 and guides them toward the breaker-bar section 74. The receiving section 70 includes opposed guide rails 86 that are adjustably mounted to the frame rails 62, 66. The guide rails 86 are adjustable to accommodate varying widths of conveyor belts 14 and, although illustrated as being substantially parallel to each other, may also be configured to converge slightly to guide the bottles 22 inwardly toward the breaker bar section 74 if desired.

The breaker bar section 74 includes a support member 90 that extends between the first and second frame rails 62, 66. The support member 90 is slideably mounted to the frame rails 62, 66 and extends above the bottles 22 traveling along the conveyor belt 14. Hanging from and slideably coupled to the support member 90 is a plurality of breaker bar assemblies 94. The breaker bar assemblies 94 each include breaker bars 98 that extend downwardly toward the conveyor belt 14 and into the incoming stream 18 of bottles 22. The breaker bars 98 contact the traveling bottles 22 and are positioned to generally align the bottles 22 with the bottle-receiving channels 38. By slideably mounting the support member 90 to the frame rails 62, 66, and by slideably mounting the breaker bar assemblies 94 to the support member 90, the breaker bars 98 are adjustable in both parallel and perpendicular directions with respect to the traveling direction of the bottles 22. As illustrated, it is preferred for adjacent breaker bar assemblies 94 to be staggered slightly upstream/downstream of each other to reduce the potential for bottle jams that might disturb the flow of bottles 22 through the system 10.

The receiving section 70 and/or the breaker bar section 74 may also include a bottle return chute 102. The illustrated bottle return chute 102 discharges bottles 22 onto the right-most edge of the conveyor belt 14 just upstream of the breaker bar section 74. Other embodiments of the invention may include a bottle return chute 102 that discharges bottles 22 into other locations of the system 10. The bottle return chute 102 is provided to account for variations in the palletization and organization of the bottles 22 after they have been organized into the staggered rows 30a, 30b by the row forming system 10. For example, certain known palletizers require that one bottle be removed from the first or last row of bottles that enters a given pallet in order to achieve a proper stacking or sorting of bottles. Still other palletizers remove an entire row of bottles from certain levels of a pallet. Such bottle-removing palletizers are well known in the industry, form no part of the present invention, and therefore, are not discussed in detail herein. The bottles removed from the pallet are delivered by such a palletizer to the return chute 102, which then returns the bottles to the row forming system 10 to be re-inserted into the bottle stream 18.

The accumulating section 78 includes the row forming components discussed above and illustrated in FIGS. 2-5, as well as additional components, and operates to organize the bottles 22 into the staggered rows 30a, 30b. FIG. 6 best illustrates the various components of the accumulating section 78. The accumulating section 78 includes a guide support assembly 106, a primary drive assembly 110, a starwheel drive assembly 114, and a jam sensor assembly 118. These assemblies cooperate to provide, among other things, the oscillatory motion of the guides 34 and the timed rotation of the starwheel assemblies 50 discussed above.

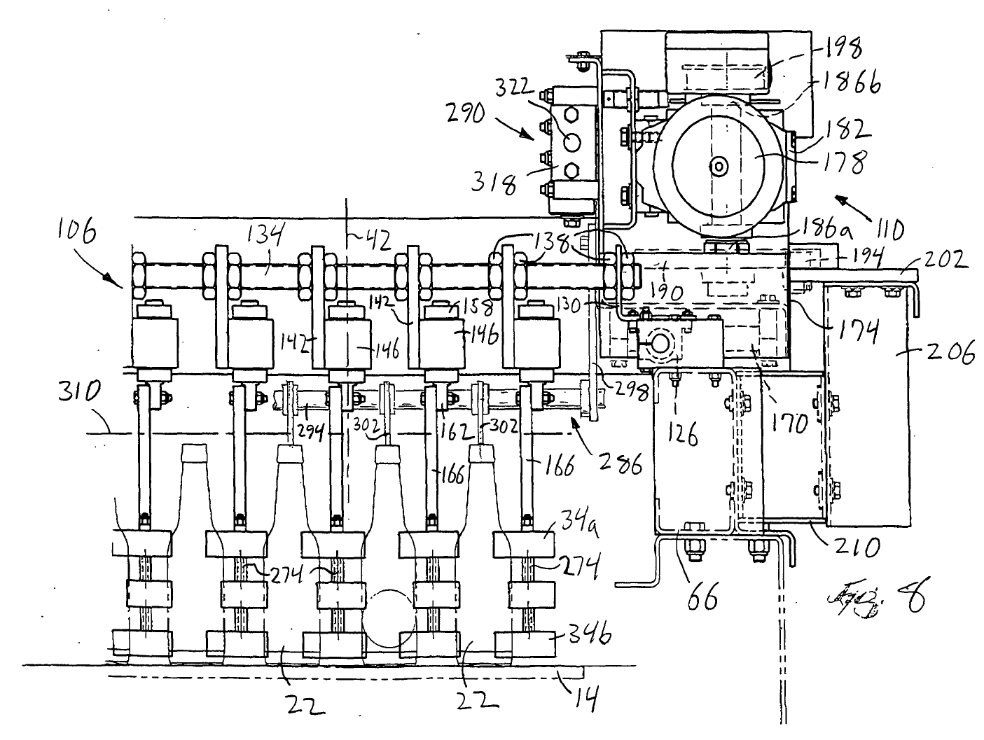

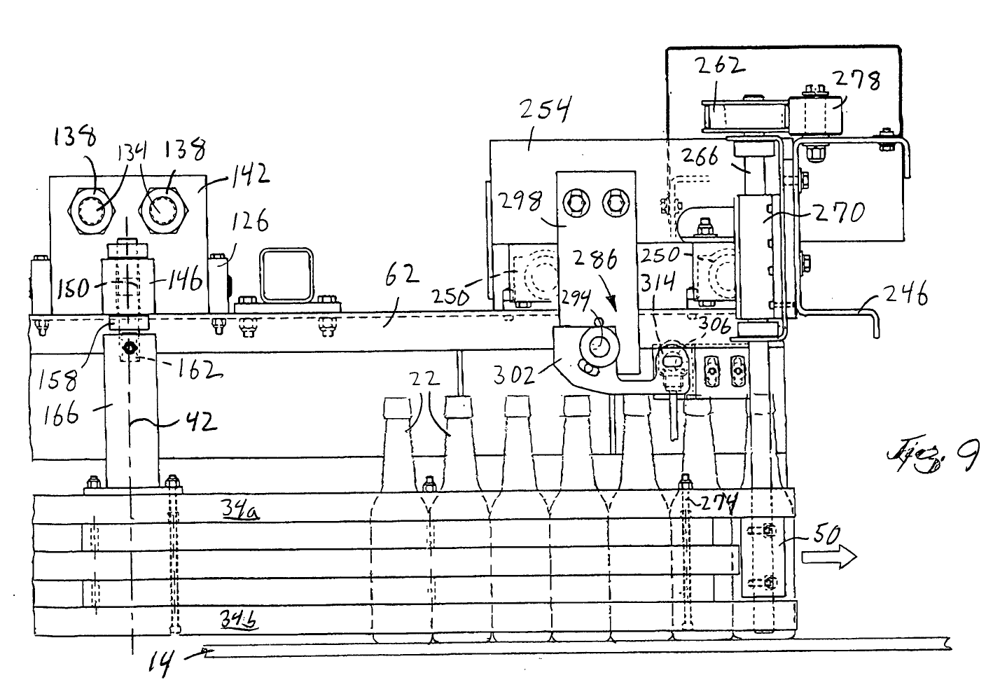

Referring also to FIGS. 7 and 8, the guide support assembly 106 pivotally supports the upstream ends 122 of the guides 34. As illustrated, certain of the upstream guide ends 122 are elongated and extend further upstream than others of the upstream guide ends 122 (see FIG. 6). This arrangement serves a similar purpose as the staggering of the breaker bar assemblies 94 in that it also reduces the likelihood of bottle jams. In addition, as the guides 34 oscillate between the first and second positions, the upstream ends 122 also oscillate slightly (see phantom lines in FIG. 2). The oscillation of the upstream ends 122 further reduces the likelihood of bottle jams and further guides the bottles 22 into the bottle receiving channels 38. The guide support assembly 106 includes two linear bearings 126 that are mounted to respective frame rails 62, 66. The linear bearings 126 allow the guide support assembly 106 to translate in a direction parallel with the traveling direction of the conveyor belt 14 (hereinafter referred to as the “flow direction”) as the guides 34 oscillate, for reasons that will become more apparent below.

Coupled to each linear bearing 126 for translation therewith are L-shaped support brackets 130. The L-shaped support brackets 130 support a pair of threaded shafts 134 that extend across the accumulating section 78 and support the guides 34. A nut 138 is tightened against each side of the L-shaped support brackets 130 to secure the threaded shafts 134 to the brackets 130. A plurality of guide positioning brackets 142 are spaced along the threaded shafts 134 and are adapted to support the guides 34. The locations of the guide positioning brackets 142 along the shafts 134 are adjustably fixed by tightening additional nuts 138 against each side of each positioning bracket 142. Thus, the locations of the guide positioning brackets 142 can be altered by changing the locations of the nuts 138 along the shafts 134.

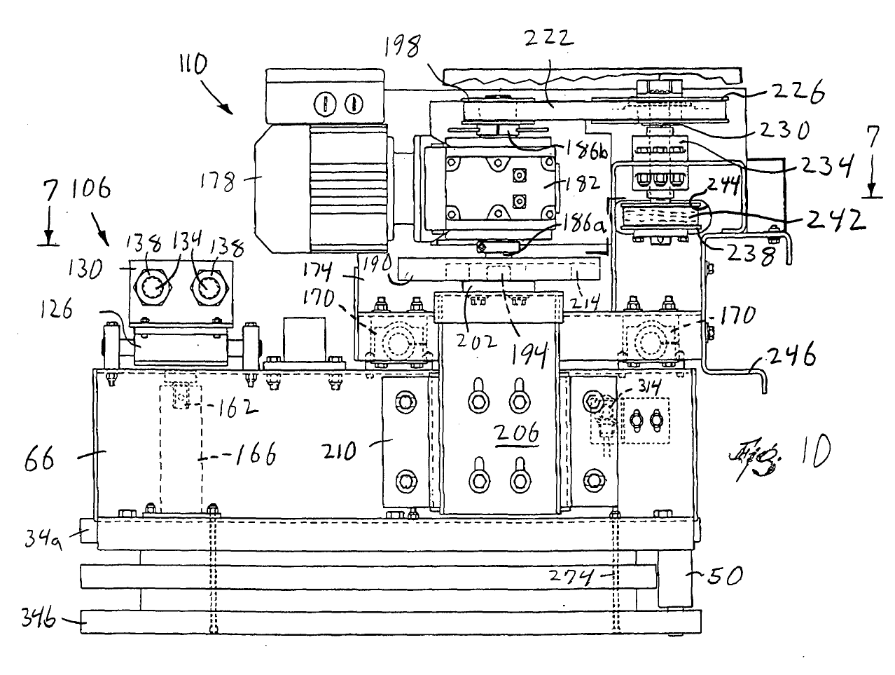

The positioning brackets 142 each include sleeve portions 146 having generally cylindrical apertures 150 (see FIG. 9) that define the individual pivot axes 42. A pin assembly 158 is received by each sleeve portion's aperture 150 and is rotatable with respect thereto about the axis 42. The pin assembly 158 includes a clevis portion 162 that is coupled to a T-shaped guide hanger bracket 166 using a suitable fastener. Each T-shaped hanger bracket 166 extends downwardly between the bottle receiving channels 38 and is coupled to a corresponding guide 34 by suitable fasteners.

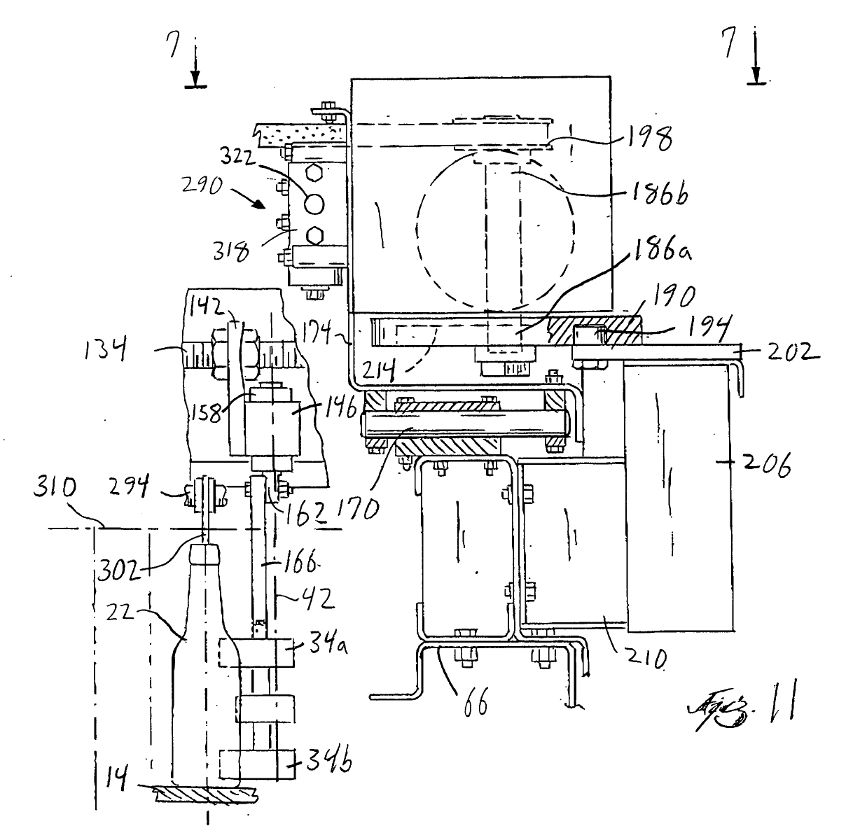

With reference also to FIG. 10, the primary drive assembly 110 is slideably mounted to the right frame rail 66 (although could also be slideably mounted to the left frame rail 62) by additional linear bearings 170 that are oriented perpendicularly to the flow direction. The linear bearings 170 have a fixed portion mounted to the right frame rail 66 and a sliding portion to which a carriage 174 is mounted for sliding movement therewith. The carriage 174 supports various components of the primary drive system 110, which are therefore also movable in a direction substantially perpendicular to the flow direction. In addition to certain components of the primary drive system 110, the star wheel drive assembly 114, the guides 34, and the starwheel assemblies 50 are also coupled to the carriage 174 and are slideably movable therewith (see FIG. 6).

An electric motor 178 is mounted to the carriage 174 using suitable brackets and fasteners, and is of suitable size and power rating to drive the various components of the accumulating section 78. As illustrated, the electric motor 178 is oriented generally parallel to the conveyor belt and drives a gearbox assembly 182 that is also mounted to the carriage 174. It should be appreciated that the motor 178 and gear box assembly 182 could be oriented differently if desired. The gearbox assembly 182 is driven by the electric motor 178 and includes two output shafts 186a, 186b that are substantially perpendicular to the conveyor belt 14. It should be appreciated that the output shafts 186a, 186b can be formed of the same shaft, as illustrated in FIG. 8, or can be two completely separate shafts that may or may not be driven at the same speeds. The first output shaft 186a is coupled to a cam disk 190 that cooperates with a follower in the form of a fixed boss 194 to provide oscillatory movement of the carriage 174. The second output shaft 186b is coupled to a drive pulley 198, which in turn rotatably drives the starwheel assemblies 50. Thus, a single electric motor 178 drives the oscillatory movement of the carriage 174, and also drives the rotation of the starwheel assemblies 50 due to the configuration of the motor 178 and the gearbox assembly 182.

With reference also to FIG. 11, the fixed boss 194 is fixedly coupled to the right frame rail 66 and, as such, does not move during operation of the system 10. A boss bracket 202 is adjustably mounted to an intermediate bracket 206 by fasteners fitted into elongated slots (see FIG. 7) formed in the boss bracket 202. The intermediate bracket 206 is in turn adjustably mounted to a frame bracket 210 also by way of slots (see FIG. 10). Similarly, the frame bracket 210 is adjustably mounted to the frame rail 66 by slots (see FIG. 10). In this respect, the location of the fixed boss 194 can be adjusted along three independent axes to control the timing of carriage oscillations 174 and the engagement of the fixed boss 194 with the cam disk 190.

The cam disk 190 defines a cam slot 214 that receives the fixed boss 194. The cam slot 214 is formed with a particular shape and profile such that rotation of the cam disk 190 results in the desired oscillatory movement of the carriage 174. One such preferred cam slot profile is discussed below, however other slot profiles could also be used to achieve a different pattern of oscillatory movement.

Referring back to FIG. 7, the cam slot 214 includes arcuate portions 218a, 218b having a generally constant radius with respect to the output shaft 186a, and arcuate portions 218c, 218d having a variable radius with respect to the output shaft 186a. As the cam disk 190 rotates (e.g. clockwise as illustrated), engagement between the fixed boss 194 and the cam slot 214 results in intermittent oscillatory movement of the carriage 174. Preferably, the cam disk 190 is rotated at a substantially constant speed such that the fixed boss 194 moves smoothly from one arcuate portion of the cam slot 214 into the next.

During cam disk 190 rotation, when the boss 194 is in the constant radius portion 218a, the carriage 174 is in a left-most position with respect to the boss 194, which corresponds to the first position of the guides 34, illustrated in FIG. 3. Due to the substantially constant arc radius of the portion 218a, the carriage 174 remains substantially stationary in the left-most position for a brief period of time. This delay in movement facilitates consistent placement of bottles 22 in the staggered row 30a as will be discussed further below. As the cam disk 190 further rotates and the fixed boss 194 enters the variable radius portion 218c, the carriage 174 is moved toward the right and the guides 34 pass through a position corresponding to that illustrated in FIG. 4. Upon still further rotation of the cam disk 190, the fixed boss 194 enters the other constant radius portion 218b. At this point, the carriage 174 is in a right-most position corresponding to the second position of the guides 34, which is illustrated in FIG. 5. As described above with respect to the constant radius portion 218a, the constant radius of the portion 218b results in the guides 34 remaining substantially stationary in the second position to facilitate consistent placement of bottles 22 in the staggered row 30b. Further rotation of the cam disk 190 causes the carriage 174 to move back toward the leftmost position as the fixed boss 194 passes through the other variable radius portion 218d. It should be appreciated that the oscillatory movement of the carriage 174 is substantially linear due to the mounting of the carriage 174 on the linear bearings 170.

FIG. 10 best illustrates the configuration of the belts and pulleys that are driven by the second output shaft 186b, and which rotatably drive the starwheel assemblies 50. As discussed above, the drive pulley 198 is secured to the second output shaft 186b for rotation therewith. A first flexible drive element in the form of a toothed belt 222, engages the drive pulley 198 and extends toward and engages an intermediate pulley 226. The intermediate pulley 226 is mounted on one end of a shaft 230 that is rotatably coupled to the carriage 174 by a bushing assembly 234. The other end of the shaft 230 has fixed thereto an output pulley 238 that drives a second flexible drive element, also in the form of a toothed belt 242. The toothed belt 242 extends though an aperture 244 in the carriage 174 and engages the starwheel drive assembly 114 to rotatably drive the starwheel assemblies 50 as discussed below. It should be appreciated that the gear ratios of the gearbox assembly 182 and the relative diameters of the various pulleys are selected to provide accurate timing between the oscillations of the carriage 174, and the rotation of the starwheel assemblies 50 as discussed above. That is, for the illustrated embodiment wherein each starwheel assembly 50 has four bottle receiving recesses 54, the pulley sizes are selected such that one oscillation of the carriage 174 from the left-most to the right-most position corresponds to approximately a quarter turn (90 rotational degrees) of each starwheel assembly 50. For the illustrated pulley sizes and gear ratios, one rotation of the cam disk 190 corresponds to approximately one-half of a rotation of each starwheel assembly 50.

Referring to FIGS. 6, 7, 9 and 10, a generally C-shaped channel section 246 is coupled to the carriage 174 and extends between the frame rails 62, 66. Additional linear bearings 250 are secured to the left frame rail 62 and are movable in a direction substantially parallel to the movement of the linear bearings 170 (e.g. perpendicular to the flow direction). A second carriage 254 is mounted to the linear bearings 250 and to the channel section 246, and therefore oscillates with the carriage 174. The various components of the starwheel drive assembly 114 are supported by the channel section 246 and the second carriage 254. Therefore, the entire starwheel drive assembly 114 oscillates during operation of the system 10.

As the toothed belt 242 extends away from the aperture 244 and out of the carriage 174, it engages a jam-sensor pulley 258. The jam-sensor pulley 258 is coupled to the jam sensor assembly 118 to detect jams in the starwheel drive system 114, as will be discussed further below. The toothed belt 242 also engages the first of a plurality of starwheel pulleys 262. Each starwheel pulley 262 is coupled to a respective starwheel assembly 50 for imparting rotation thereto. The starwheel pulleys 262 include notches that engage the teeth of the toothed belt 242 to ensure consistent timed rotation of the starwheel assemblies 50. As best shown in FIG. 9, each starwheel pulley 262 is fixed to a starwheel drive shaft 266 that is rotatably carried by a bushing assembly 270 that is in turn coupled to the channel section 246. The drive shafts 266 rotate within the bushing assemblies 270 about axes that are substantially perpendicular to the conveyor belt 14. The drive shafts 266 extend downwardly toward the conveyor belt 14 between the bottle receiving channels 38. The ends of the drive shafts 266 support the downstream ends of the guides 34 as well as the starwheel assemblies 50. The drive shafts 266 extend through bores formed in the guides 34 large enough that the drive shafts 266 rotate freely therein.

As illustrated, the guides 34 include an upper guide 34a and a lower guide 34b that are coupled together by carriage bolts 274. The drive shafts 266 extend through the upper and lower guides 34a, 34b and through the starwheel assemblies 50, which are positioned between the upper and lower guides 34a, 34b. The starwheel assemblies 50 are fixed to the drive shafts 266 for rotation therewith such that rotation of the starwheel pulleys 262 rotates the starwheel assemblies 50. The upper and lower guides 34a, 34b are held to the drive shafts 266 using snap rings or similar retention devices.

As discussed above, the carriage 174 is slideably mounted to the linear bearings 170. As such, the oscillatory motion of the starwheel assemblies 50, and in particular the drive shafts 266, is substantially linear and perpendicular to the traveling direction of the conveyor belt 14. However, because the guides 34 are configured to arcuately pivot about the axes 42, the pivot axes must be allowed to move parallel to the travelling direction of the conveyor belt 14. It is for this reason that the guide support assembly 106, and in particular the guide hanger brackets 166, are supported by the linear bearings 126 and are therefore moveable parallel to the travelling direction. Specifically, as the starwheel assemblies 50 oscillate between their right-most and left-most position, the pivot axes 42 move parallel to the travelling direction between an upstream position and a downstream position. In the illustrated construction, the pivot axes 42 are in the upstream position when the starwheel assemblies 50 are in the left-most position or the right-most position, and in the downstream position when the starwheel assemblies 50 are approximately mid-way between the left-most and right-most positions.

Referring again to FIGS. 6 and 7, positioned between each starwheel pulley 262 is an idler pulley 278 that engages the non-toothed side of the toothed belt 242. The idler pulleys 278 ensure that driving engagement is maintained between the toothed side of the toothed belt 242 and the starwheel pulleys 262. Specifically, the toothed belt 242 extends out of the carriage 174 over the jam-sensor pulley 258, and then follows a serpentine path through the starwheel pulleys 262 and the idler pulleys 278, drivingly engaging each starwheel pulley 262 to rotatably drive a respective starwheel assembly 50. Movably mounted to the second carriage 254 is a take-up pulley 282. The take-up pulley 282 is movable with respect to the second carriage 254 in a direction perpendicular to the flow direction and is provided to maintain adequate tension on the toothed belt 242. The take-up pulley 282 may be spring loaded and biased in a belt-tensioning direction, or may also be manually tensioned by an operator and then held fixed with respect to the second carriage 254 for proper belt tensioning.

Referring now specifically to FIGS. 6-9, the jam sensor assembly 118 includes a feed jam sensor assembly 286, and a starwheel jam sensor assembly 290. Both jam sensor assemblies 286, 290 are provided and are operable to stop operation of the system 10 by at least stopping movement of the conveyor belt 14 and stopping rotation of the electric motor 178 in the event of a system jam. System jams can occur due to, among other reasons, an interruption of the feeding of bottles 22 to the starwheel assemblies 50, the tip over of a bottle in the receiving, breaker bar, or accumulating sections 70, 74, 78, or due to a jam of some type in the starwheel assemblies 50 themselves. Both jam sensor assemblies 286, 290 are coupled to the carriage 174 for oscillation therewith.

The feed jam sensor assembly 286 includes a threaded shaft 294 (similar to the shafts 134) that extends between the carriage 174 and the second carriage 254. Sensor brackets 298 are coupled to the carriage 174 and the second carriage 254 and support the ends of the threaded shaft 294. The sensor brackets 298 are coupled to the carriages 174, 254 using fasteners extended through slots formed in the brackets 298, such that the height of the threaded shaft 294 above the conveyor belt 14 may be adjusted as required. Substantially U-shaped bottle engaging members 302 (see FIG. 9) are pivotally mounted on one end to the threaded shaft 294 and extend forwardly over the bottle receiving channels 38 substantially parallel to the flow direction. The bottle engaging members 302 engage the tops of bottles 22 that are being carried toward the starwheel assemblies 50. Each bottle engaging member 302 includes an aperture 306 on an end opposite the end that is mounted to the threaded shaft 294. The apertures 306 are positioned such that, when all the bottle receiving channels 38 are sufficiently filled with bottles 22, each aperture 306 is substantially aligned with and generally surrounds a sensing axis 310 that extends across the accumulating section 78 parallel to the conveyor belt 14, and perpendicular to the flow direction.

The feed jam sensor assembly 286 also includes an electronic eye 314 adjustably mounted to the second carriage 254, which provides a sensing beam that is substantially aligned with the sensing axis 310. Thus, when each bottle receiving channel 38 contains a sufficient number of bottles 22, the sensing beam has an unobstructed path through the apertures 306 to the carriage 174. An additional sensor may be mounted to the carriage 174 that detects the sensing beam, or, a reflector may be provided on the carriage 174 that reflects the sensing beam back through the apertures 306 to the electronic eye 314 as is well known in the art. In the event of a jam or a bottle tip over upstream of the feed jam sensor assembly 286, the delivery of bottles 22 to one or more of the bottle receiving channels 38 will likely be interrupted. When there is no longer an upright bottle 22 positioned below a respective bottle engaging member 302, that member will pivot about the threaded shaft 294, resulting in misalignment of the aperture 306 and the sensing axis 310 and at least temporary obstruction of the sensing beam.

In response to sensing the obstruction of the sensing beam, appropriate control circuitry can be configured to immediately interrupt electrical power to the electric motor 178 and to the drive system of the conveyor belt 14, thereby halting the delivery and sorting of bottles 22 until an operator can clear the jam. Alternatively, the control circuitry can be configured to wait for a predetermined period of time before shutting down the system 10 to allow the jam to clear itself, or to account for relatively small voids between subsequent bottles. For example, if a tipped bottle enters one of the bottle receiving channels 38, the corresponding bottle engaging member 302 will pivot to obstruct the sensing beam. Because the downstream ends of the guides 34 are curved to prevent a tipped bottle from reaching the starwheel assemblies 50, additional bottles 22 are prevented from moving along the bottle receiving channel 38. Therefore, the bottle engaging member 302 will continue to obstruct the sensing beam indefinitely. On the other hand, if a void forms between subsequent bottles 22 in the bottle receiving channel 38, the bottle engaging member 302 will pivot to obstruct the sensing beam only when the void passes therebelow. However, when the next bottle passes below the bottle engaging member 302, the bottle engaging member 302 will be pivoted upwardly and the sensing beam will no longer be obstructed. Depending upon the size of the void, it may not be necessary to shut down the system 10. The predetermined period of time is generally determined experimentally, and, in some instances, may substantially correspond with the time required for the starwheel assemblies to rotate approximately 90 degrees.

The starwheel jam sensor assembly 290 is provided to detect jams in the starwheel drive assembly 114. Referring to FIG. 7, the starwheel jam sensor assembly 290 includes the jam sensor pulley 258 discussed above, and an axial load sensor that may be in the form of a spring, strain gage, or substantially any other item that is somehow responsive to a change in an applied load. In the illustrated embodiment, the load sensor includes a slider block 318 that is slideably mounted to the carriage 174. The jam sensor pulley 258 is rotatably mounted to the slider block 318 and the slider block 318 is biased toward a belt-tensioning position (e.g. rearwardly or opposite the flow direction as illustrated) by an axial spring 322. In the event of a jam in the starwheel drive assembly 118, one or more of the starwheel assemblies 50 and their respective starwheel pulleys 262 may be prevented from freely rotating due to, for example, improper alignment of a bottle 22 with a bottle receiving recess 54. In the event rotation of a starwheel assembly 50 is restricted, tension in the toothed belt 242 will increase. In response to the increased tension in the toothed belt 242, the jam sensor pulley 258 and the slider block 318 will be urged forwardly in the flow direction, thereby overcoming the biasing force provided by the spring 322. Suitable sensors, such as contact sensors, position sensors, and/or strain gages are provided to detect such movement of the slider block 318. In response to sensing movement of the slider block 318 beyond a predetermined position, the control circuitry cuts electrical power to the various system drive components, as discussed above with respect to the feed jam sensor assembly 286.

In some instances, it may be possible to clear jams by operating the system 10 in reverse. As such, the control circuitry may be configured to perform pre-programmed remediation procedures in an attempt to automatically clear jams. For example, if a relatively large void is detected by the feed jam sensor assembly 286 such that a void downstream of the starwheel assemblies 50 is probable, the system 10 may automatically run in reverse for a predetermined period of time in an effort to correct the void. Jams detected by the starwheel jam sensor assembly 290 may result in similar remediation procedures. If none of the remediation procedures are able to successfully correct the jam or void, the operator would be notified that manual intervention is required and the system 10 would be automatically shut down.

To further illustrate various aspects of the invention, operation of the system 10 will be further described with respect to a single bottle 22 as the bottle 22 moves from the receiving section 70, through the breaker bar section 74 and the accumulating section 78, and to the discharge section 82. The bottle 22 is deposited on the conveyor belt 14 upstream of the system 10. The conveyor belt 14 first delivers the bottle 22 through the receiving section 70 where the guide rails 86 can divert the bottle 22 inwardly if required. Generally the bottle 22 will only be diverted if the bottle 22 is placed near either edge of the conveyor belt 14, or if the guide rails 86 are arranged to divert the bottles 22 into a breaker bar section 74 that is significantly more narrow than the conveyor belt 14.

Once the bottle 22 passes through the receiving section 70, the bottle enters the breaker bar section 74 where it may contact one or more of the breaker bars 98. As discussed above, the breaker bar assemblies 94 are adjustably positionable over the conveyor belt 14 such that the breaker bars 98 contact and move the bottles 22 to generally align them with the bottle receiving channels 38. Thus, upon traveling through the breaker bar section 74, the bottle 22 is generally aligned with one of the bottle receiving channels 38. As the bottle 22 reaches the accumulating section 78, one or more of the upstream ends 122 of the guides 34 may contact the bottle 22 to further guide the bottle 22 toward the bottle receiving channel 38. As discussed above, the pivotal movement of the guides 34 about the pivot axes 42 results in oscillatory movement of the upstream ends 122 of the guides 34. This oscillatory movement of the upstream ends 122 reduces the likelihood of the bottle 22 directly impacting the upstream end 122 and possibly tipping over and creating a jam. In addition, if a large number of bottles 22 are being delivered to the accumulating section 78, the oscillatory movement of the upstream ends 122 serves to jostle the bottles 22. This reduces the likelihood that two or more bottles that may be contacting each other become lodged in the entrance of a bottle receiving channel 38 and block the flow of bottles 22.

Once the bottle 22 has entered the bottle receiving channel 38, the bottle 22 contacts an additional bottle 22 that is in front of it and begins to slideingly engage the conveyor belt 14. As discussed above, the guides 34 oscillate perpendicularly with respect to the flow direction between the first and second positions. Movement of the guides 34 slides the bottle 22 back and forth along the conveyor belt 14 as the bottle travels along the bottle receiving channel 38. In addition, the starwheel assemblies 50 rotate at a rotational velocity such that bottles 22 in the bottle receiving recesses 54 move in a downstream direction slower than the conveyor belt. As such, the bottle 22 moves in a downstream direction slower than the conveyor belt 14, and slideingly engages the conveyor belt 14 in a corresponding manner. As the bottle 22 continues toward the starwheel assembly 50, the bottle 22 reaches the feed jam sensor assembly 286. The bottle 22 passes below the feed jam sensor assembly 286 and the top of the bottle 22 contacts the associated bottle engaging member 302. The bottle 22 thus maintains the respective aperture 306 in the bottle engaging member 302 in alignment with the sensing axis 310 such that the sensor beam from the electronic eye 314 is not interrupted. If the bottle 22 were tipped over, or if the bottle 22 were for some reason unable to reach the bottle engaging member 302, the bottle engaging member 302 would pivot about the threaded shaft 294, thereby interrupting the sensing beam and subsequently halting operation of the system 10, if required.

After the bottle 22 has passed through the feed jam sensor assembly 286, the bottle 22 engages one of the starwheel assemblies 50 and is received by one of the bottle receiving recesses 54. As the starwheel assembly 50 rotates, the guides 34 oscillate toward either the left-most or the right-most position. Just before the bottle 22 is released from the starwheel assembly 50 (i.e. just before the downstream end 58 of the bottle receiving recess 54 points substantially in the direction of travel of the conveyor belt 14), the oscillatory motion of the guides 34 is halted such that the guide 34 remains substantially stationary in the left-most or the right-most position. As discussed above, the halting of the oscillatory motion corresponds to the fixed boss 194 being positioned in one of the constant radius arcuate portions 218a, 218b of the cam slot 214 in the cam disk 190. While the guide 34 is substantially stationary, the starwheel assembly 50 continues to rotate until the bottle 22 is released from the bottle receiving recess 54 and carried further downstream by the conveyor belt 14. As the bottle 22 is released from the starwheel assembly 50, the bottle 22 is substantially aligned with other bottles 22 that are substantially simultaneously released from the other starwheel assemblies 50, thereby forming an aligned group of bottles 22 that define one of the staggered rows 30a, 30b, depending upon whether the guides 34 were in the left-most or the right-most position.

The oscillation of the guides 34 is preferably such that the staggered rows 30a, 30b are offset from one another by a distance that is approximately 0.866 times the bottle diameter. This distance corresponds to the height of an equilateral triangle having sides that are equal to the bottle diameter. This staggering is such that when the bottles reach a palletizer or other downstream handling equipment, and the rows 30a, 30b are brought into contact with each other, the rows 30a, 30b are properly nested with one another to form a compact, void-free grouping of bottles for storage and/or shipping purposes.

The invention as described above has been directed to the organization and delivery of glass bottles (e.g., beer bottles), however, it should be appreciated that the teachings of the above invention may be applied to the organization and delivery of various other types of containers. The above description has been provided as an example of one preferred embodiment of the invention and should not be regarded as limiting.

Various features of the invention are set forth in the following claims.

1. A row former for arranging an unorganized stream of articles into a plurality of rows, the row former comprising:
a conveyor for conveying the articles in a flow direction;
a frame adjacent the conveyor;
a plurality of elongated guides coupled to the frame and supported thereby for oscillatory movement above the conveyor between a first position and a second position;
a plurality of guide channels defined by and extending between the guides to receive and guide the articles; and
a plurality of shafts supported by the frame and moving in timed relation with respect to the oscillating guides to intermittently allow articles to flow out of the guide channels.

2. The row former of claim 1, wherein the guides oscillate in a direction that is substantially perpendicular to the flow direction.

3. The row former of claim 1, wherein a downstream end of each guide oscillates in a direction substantially perpendicular to the flow direction, and wherein an upstream end of each guide is pivotally coupled to the frame.

4. The row former of claim 3, wherein the upstream end of each guide is further coupled to the frame for translational movement in a direction substantially parallel to the flow direction.

5. The row former of claim 1, wherein each shaft retains an individual article in the guide channel until the guides reach one of the first and second positions, at which time each shaft allows an individual article to flow out of a respective guide channel.

6. The row former of claim 1, further comprising a plurality of starwheels coupled to the shafts for rotation therewith, each starwheel defining a plurality of article receiving recesses.

7. The row former of claim 6, wherein the article receiving recesses each receive an individual article and retain each individual article in the guide channel until the guides reach one of the first and second positions.

8. The row former of claim 7, wherein when the guides reach one of the first and second positions, a downstream end of each article-receiving recess rotates to a position that is substantially tangent to the flow direction, thereby releasing the articles and allowing the articles to flow out of the guide channels.

9. The row former of claim 6, wherein a portion of each starwheel extends into a respective one of the guide channels to regulate the flow of articles out of the respective guide channel.

10. The row former of claim 1, wherein one article is allowed to flow from each guide channel each time the guides reach one of the first and second positions, and wherein no articles are released when the guides are between the first and second positions.

11. The row former of claim 1, further comprising:
a carriage slideably coupled to the frame for translational movement in a direction that is substantially perpendicular to the flow direction;
a motor supported by the carriage and drivingly coupled to the shafts for rotation thereof;
a cam rotatably driven by the motor; and
a cam follower coupled to the frame and engaged with the cam,
wherein the plurality of guides and the plurality of shafts are at least partially supported by the carriage, and wherein rotation of the cam imparts oscillatory movement to the carriage.

12. An article row former for arranging an unorganized stream of generally cylindrical articles into a plurality of rows, the article row former comprising:
a conveyor for conveying the articles in a flow direction;
a frame adjacent the conveyor;
a carriage coupled to the frame for translational movement in a direction substantially perpendicular to the flow direction;
a motor supported by the carriage for movement therewith;
a cam supported by the carriage and drivingly coupled to the motor for rotation thereby;
a cam follower fixedly coupled to the frame and engaging the cam, the carriage oscillating in response to rotation of the cam; and
a plurality of guides, each guide having a first end supported by the carriage for oscillation therewith, and a second end supported by the frame.

13. The article row former of claim 12, wherein the carriage oscillates between a first position and a second position.

14. The article row former of claim 13, wherein the cam defines a cam profile having a first constant radius portion, a second constant radius portion, a first variable radius portion, and a second variable radius portion, and wherein when the cam follower is in the first constant radius portion, the carriage is substantially stationary in the first position, and when the cam follower is in the second constant radius portion, the carriage is substantially stationary in the second position.

15. The article row former of claim 14, wherein when the cam follower is in one of the first and second variable radius portions, the carriage is between the first and second positions.

16. The article row former of claim 12, further comprising a plurality of starwheels, each starwheel supported by the carriage and rotatably coupled to a downstream end of a respective guide, wherein each starwheel is drivingly coupled to the motor for rotation thereby.

17. The article row former of claim 16, wherein the starwheels synchronously rotate to intermittently allow individual containers to flow from respective guide channels, thereby forming the plurality of rows.

18. The article row former of claim 17, wherein the carriage oscillates between a first position and a second position, and wherein the starwheels rotate in timed relation with the oscillation of the carriage to allow the individual containers to flow from respective guide channels only when the carriage is in one of the first and second positions.

19. An article row former for arranging an unorganized stream of articles into a plurality of rows, the article row former comprising:
a conveyor for conveying articles in a flow direction;
a frame adjacent the conveyor;
a plurality of article guides supported by the frame and defining a plurality of substantially parallel guide channels that extend in the flow direction, each guide including an upstream end that guides individual articles into one of the guide channels, and a downstream end having a curved portion that diverts the articles in a direction that is angled with respect to the flow direction prior to releasing the articles from the guide channels.

20. The article row former of claim 19, wherein each guide channel has a width that substantially corresponds to a diameter of the articles.

21. The article row former of claim 19, further comprising a discharge assembly coupled to the downstream end of the guides and operating to intermittently allow articles to flow from the guide channels, and wherein the curved portion prevents a tipped article from reaching the discharge assembly.

22. The article row former of claim 19, further comprising a feed jam sensor positioned over the guide channels upstream of the curved portions, the feed jam sensor operable to detect a tipped article in the guide channel.

23. An article row former for arranging an unorganized stream of articles into a plurality of rows, the article row former comprising:
a frame;
a plurality of guides supported by the frame and defining guide channels, each guide having an upstream end and a downstream end;
a plurality of starwheels each rotatably coupled to a downstream end of a respective guide to control the release of articles from the guide channels;
a plurality of drive pulleys, each drive pulley coupled to a respective starwheel for imparting rotation thereto;
a motor coupled to the frame;
a flexible drive member driven by the motor and engaging each drive pulley for imparting rotation thereto;
a sensor pulley coupled to the frame and engaging the flexible drive member; and
a sensor operatively associated with the sensor pulley to sense movement of the sensor pulley in response to an increase in tension of the flexible drive member.

24. The article row former of claim 23, wherein the sensor pulley is slideably coupled to the frame and wherein the sensor is a position sensor for sensing movement of the sensor pulley.

25. The article row former of claim 23, wherein the sensor is a load sensor.

26. The article row former of claim 23, wherein the sensor pulley is slideably coupled to the frame and wherein the sensor is a micro-switch that is actuated when the sensor pulley moves in response to the increase in tension of the flexible drive member.

27. The article row former of claim 23, further comprising a plurality of idler rollers disposed between adjacent drive pulleys and engaging the flexible drive member to guide the flexible drive member along a serpentine path.

28. An article row former for arranging an unorganized stream of articles into a plurality of rows, the article row former comprising:
a conveyor for conveying articles in a flow direction;
a frame having a first frame rail on one side of the conveyor, and a second frame rail on an opposite side of the conveyor;
a support assembly slideably coupled to at least one of the frame rails for movement substantially parallel to the flow direction;
a carriage assembly slideably coupled to the frame rails for movement substantially perpendicular to the flow direction;
a plurality of guides, each guide having an upstream end pivotally coupled to the support assembly and a downstream end pivotally coupled to the carriage assembly.

29. A method for clearing jams in an article row former, the article row former including a conveyor for conveying articles in a flow direction, a frame adjacent the conveyor, and a plurality of article guides supported by the frame and defining a plurality of substantially parallel guide channels that extend in the flow direction, the method comprising:
sensing the absence of an article in one of the guide channels;
waiting for a period of time corresponding to a feed rate at which articles flow from the guide channels;
automatically performing jam remediation operations in response to continued absence of an article in the one guide channel after waiting for the period of time;
operating the article row former normally after performing the jam remediation operations;
checking for the continued absence or presence of an article in the one guide channel; and
alerting an operator in response to a continued absence of an article in the one guide channel.

30. The method of claim 29, wherein performing jam remediation operations includes operating the row former in reverse.

31. The method of claim 30, wherein sensing the absence of an article in one of the guide channels includes sensing the movement of an article engaging member that is supported above the guide channels.
